(19) United States
(12) Patent Application Publication
(10) Pub. No.: US 2013/0083965 A1
(43) Pub. Date: Apr. 4, 2013

(54) APPARATUS AND METHOD FOR DETECTING OBJECT IN IMAGE

(71) Applicant: ELECTRONICS AND TELECOMMUNICATIONS R, Daejeon (KR)

(72) Inventors: Ji Hoon Joung, Daejeon (KR); Michael Sahngwon Ryoo, Daejeon (KR); Jae-Yeong Lee, Daejeon (KR); Sunglok Choi, Daejeon (KR); Wonpil Yu, Daejeon (KR); Seung Hwan Park, Daejeon (KR); Christiand, Daejeon (KR); Yu-Cheol Lee, Daejeon (KR)

(73) Assignee: ELECTRONICS AND TELECOMMUNICATIONS RESEARCH INSTITUTE, Daejeon (KR)

(21) Appl. No.: 13/644,529

(22) Filed: Oct. 4, 2012

(30) Foreign Application Priority Data
Oct. 4, 2011 (KR) 10-2011-0100635

(51) Int. Cl. G06K 9/46

(52) U.S. Cl. CPC G06K 9/4671
USPC 382/103

(57) ABSTRACT

An apparatus and method detects an object in an original image captured by an image capturing device. The apparatus and method detects a location of the object using a thermal image for the captured image, designates a region of the detected object as an image inpainting region, restores a region corresponding to the region of the detected object using its surrounding information, examines a difference between the restored image and the original image, and separates an object region from the original image, thereby more accurately detecting the object.

### RELATED APPLICATION(S)

This application claims the benefit of Korean Patent Application No. 10-2011-0100635, filed on Oct. 4, 2011, which is hereby incorporated by references as if fully set forth herein.

### FIELD OF THE INVENTION

The present invention relates to a system for detecting an object in an image, and more particularly, to an apparatus and method for detecting an object in an original image captured by an image capturing device such as a camera.

### BACKGROUND OF THE INVENTION

In general, when an image capturing device such as a camera detects an object, important performance indicators in an object detection algorithm include a detection speed representing how fast an object can be detected, a detection rate representing how many objects are detected, a false detection rate representing how many false objects are detected, how well a region of a detected object is expressed, and so on.

At this time, in case of detecting an object using a thermal image, since a temperature range of the object is narrow, a detection speed is low, and a false detection rate is high. Therefore, in case of detecting the object using the thermal image, an object detection method capable of increasing the detection speed and reducing the false detection rate is required.

Meanwhile, in case that a physical hardware operates based on an object detection result, e.g., pictures are taken after face recognition, a robot picks up an object after recognizing the object, an unmanned vehicle evades or stops after recognizing a human being, and so on, it is necessary to improve the false detection rate for the object to stably manage an overall system.

Korean patent publication number 10-2010-0083498, published on Jul. 22, 2010, discloses an image restoring apparatus and method employing a scheme of setting a part of a target image region to be restored according to an image restoring request as a restore image region to be preferentially restored.

### SUMMARY OF THE INVENTION

In view of the above, the present invention provides an apparatus and method for accurately detecting an object in an original image captured by an image capturing device.

In accordance with an aspect of the present invention, there is provided an apparatus for detecting an object in an input image, the apparatus including: an object detecting unit configured to detect the object from the input image using a thermal image; an inpainting region setting unit configured to set up an inpainting region based on the object detection result of the object detecting unit; a restoring unit configured to restore the inpainting region using its surrounding information in the input image; a similarity comparing unit configured to determine whether or not the object is present in the input image by comparing the input image with a restored image where the inpainting region is restored; and an object region separating unit configured to extract an object region based on a difference between the restored image and the input image if it is determined that the object is present in the input image.

The object detecting unit may detect the object using the thermal image by sequentially moving a region of a fixed size within the input image according to a sliding window scheme.

The object detecting unit may count the number of pixels having a temperature of an object being searched for in the fixed sized region using the thermal image to output a counted pixel number, and check the presence of the object by applying an object verification algorithm to the fixed sized region if the counted pixel number is greater than or equal to a reference value.

The object detecting unit may not apply the object verification algorithm to the fixed sized region if the counted pixel number is smaller than the reference value.

The fixed sized region may be set to a rectangle or a basic diagram.

The inpainting region setting unit may change a shape of the inpainting region to correspond to a shape of the object when setting the inpainting region.

The similarity comparing unit may calculate a similarity value between the restored image and the input image and determine that the object is present in the inpainting region if the similarity value is greater than a predetermined reference value.

The calculation of the similarity value may be performed by a similarity comparing method using a histogram between the restored image and the input image, a method using dynamic time warping, a method of raising and adding a difference between the restored image and the input image, or a method of obtaining a difference between the restored image and the input image and counting pixels corresponding to a difference that is greater than a preset value.

The object region separating unit may extract panorama information of the object through the comparison of the restored image and the input image, reflect a prior probability of a location of the object and an image separation result for the input image onto the panorama information, and separate the object region from the input image.

In accordance with another aspect of the present invention, there is provided a method of detecting an object in an image, the method including: detecting the object from the input image using a thermal image; setting an inpainting region based on the object detection result; restoring the inpainting region using its surrounding information in the input image; comparing the input image with a restored image where the inpainting region is restored and determining whether or not the object is present; and extracting an object region from the input image by obtaining a difference between the restored image and the input image if it is determined that the object is present.

Detecting the object may include detecting the object using the thermal image by sequentially moving a region of a fixed size within the input image according to a sliding window scheme.

Detecting the object may include counting the number of pixels having a temperature of an object being searched for in the fixed sized region using the thermal image and outputting a counted pixel number, and checking the presence of the object by applying an object verification algorithm to the fixed sized region if the counted pixel number is greater than or equal to a reference value.

Detecting the object may further include un-applying the object verification algorithm to the fixed sized region if the counted pixel number is smaller than the reference value.

The fixed sized region may be set to a rectangle or a basic diagram.

The inpainting region may be set to various diagrams corresponding to a shape of the object.

Determining whether or not the object is present may include obtaining a similarity value by measuring the similarity between the restored image and the input image; and determining that the object is present in the inpainting region if the similarity value is greater than a predetermined reference value.

Measuring the similarity may include performing a similarity comparing method using a histogram between the restored image and the input image, a method using dynamic time warping, a method of raising and adding a difference between the restored image and the input image, or a method of obtaining a difference between the restored image and the input image and counting pixels corresponding to a difference that is greater than a preset value.

Extracting the object region may include extracting panorama information of the object through the comparison between the restored image and the input image, reflecting a prior probability of a location of the object and an image separation result for the input image onto the panorama information, and separating the object region from the input image.

### BRIEF DESCRIPTION OF THE DRAWINGS

The above and other objects and features of the present invention will become apparent from the following description of embodiments given in conjunction with the accompanying drawings, in which:

FIG. 1 illustrates a block diagram of an apparatus for detecting an object in an image in accordance with an embodiment of the present invention;

FIG. 2 illustrates a view of detecting an object using a sliding window scheme in accordance with an embodiment of the present invention;

FIGS. 3A, 3B, and 3C illustrate views of setting inpainting regions in accordance with an embodiment of the present invention;

FIGS. 4A, 4B and 4C illustrate examples of restoring the inpainting region using its surrounding information in accordance with an embodiment of the present invention;

FIG. 5 illustrates a conceptual view of determining whether an object is present or not after comparing a restored image with an original image in accordance with an embodiment of the present invention; and

FIG. 6 illustrates a view of separating an object region from an original image in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

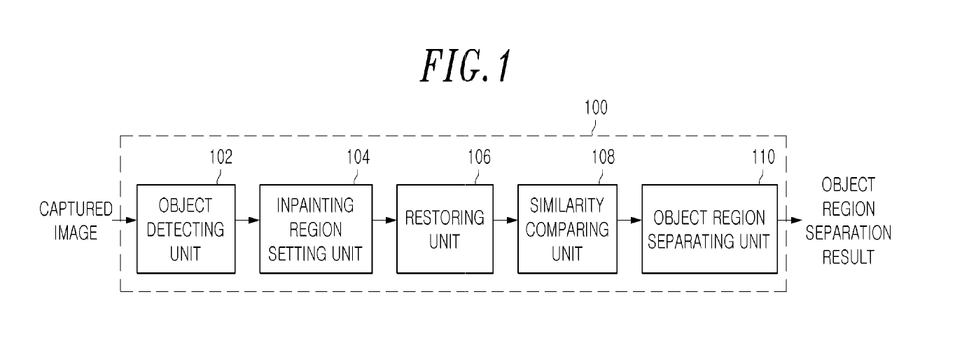

FIG. 1 illustrates a block diagram of an apparatus for detecting an object in an image in accordance with an embodiment of the present invention.

Referring to FIG. 1, the object detecting device 100 includes an object detecting unit 102, an inpainting region setting unit 104, a restoring unit 106, a similarity comparing unit 108, and an object region separating unit 110.

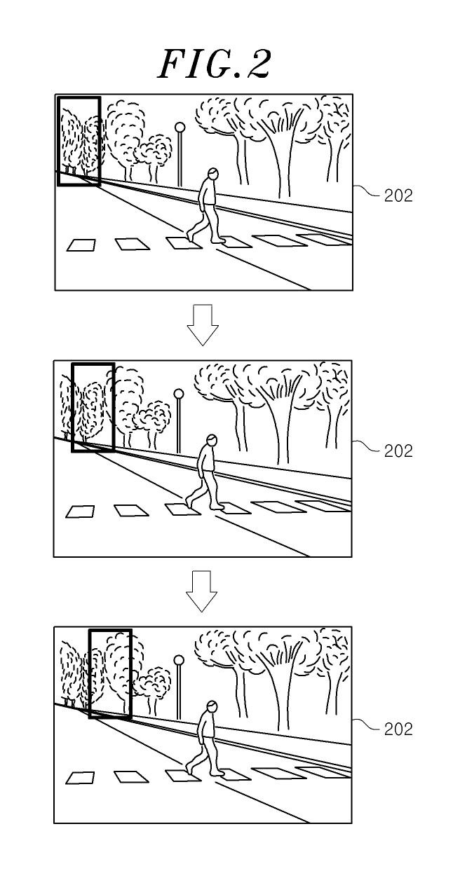

The object detecting unit 102 detects an object in an input image, which may be a captured image provided by an image capturing device such as a camera, using a thermal image. The object detecting unit 102 uses a sliding window scheme to detect the object. According to the sliding window scheme, whether or not the object is present in a target region is determined by moving the target region 202 of a basic diagram or a rectangle having a fixed size, as shown in FIG. 2.

More specifically, in case of detecting the object in the thermal image using the sliding window scheme, as shown in FIG. 2, the number of pixels, having a temperature of an object being searched for, in the rectangular target region is counted. If the counted pixel number is smaller than a reference pixel number, an object verification algorithm is not applied to the target region. Meanwhile, if the counted pixel number is greater than or equal to the reference pixel number, the object verification algorithm is applied to the target region to detect the object.

In order to count the number of pixels having a certain temperature in the rectangular target region in a short time, a value of a pixel, which is within a predetermined temperature range in the input image, is converted to “1”. However, a value of a pixel, which is out of the predetermined temperature range, is converted to “0”. After that, the pixel value “1” and the pixel value “0” are used to generate an integral image that is in turn used to detect the object.

In response to information on that the object is present in the input image from the object detecting unit 102, the inpainting region setting unit 104 sets an inpainting region for image inpainting, the inpainting region including a region that is determined as the object is present therein. The image inpainting is a technology of restoring a region that was lost or deleted in an image, e.g., a picture or video, which is captured by an image capturing device such as a camera, using surrounding information of the region to be consistent with its surrounding environment. The inpainting region setting unit 104 sets the inpainting region based on the object detection result from the object detecting unit 102 and provides the inpainting region to the restoring unit 106 so that the restoring unit 106 restores an image using the image inpainting technology.

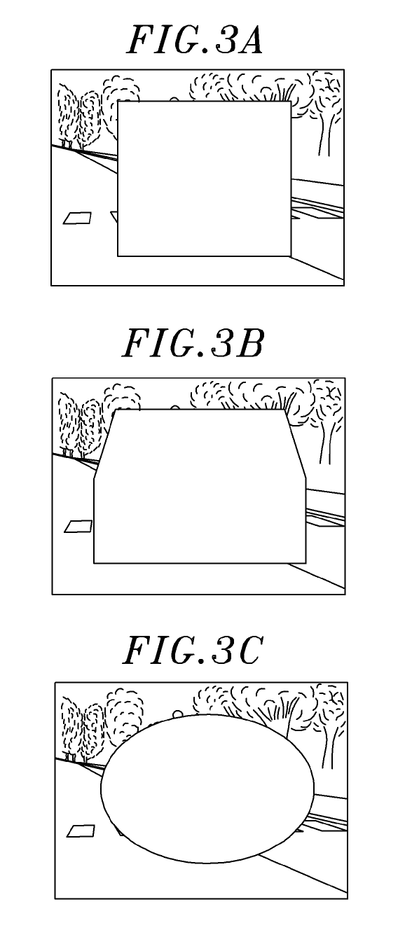

FIGS. 3A, 3B and 3C illustrate that the inpainting region setting unit 104 sets the inpainting region based on the object detection result from the object detecting unit 102. The inpainting region setting unit 104 may employ different inpainting regions such as a quadrangle, a trapezoid, and a circle, as shown in FIGS. 3A, 3B and 3C, to fit the object being searched for when assigning the inpainting region to the detected object.

The restoring unit 106 restores the inpainting region set up by the inpainting region setting unit 104 using its surrounding information to be consistent with its surrounding environment.

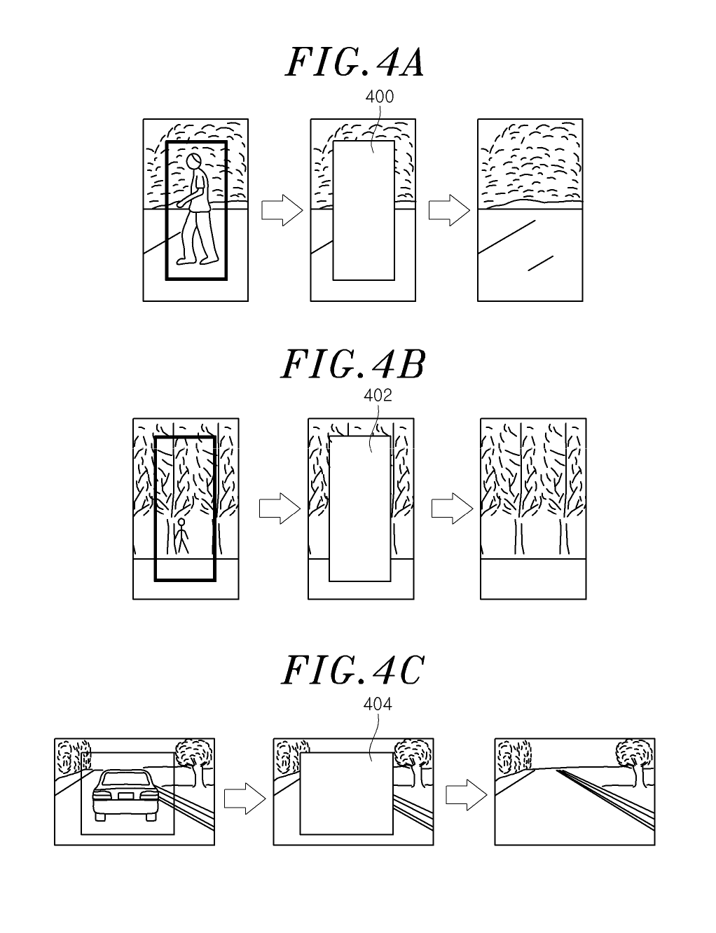

FIGS. 4A, 4B and 4C illustrate examples of restoring the inpainting region set up by the inpainting region setting unit 104 using its surrounding information to be consistent with its surrounding environment.

FIG. 4A shows an example of an inpainting region 400 that is set to include a location where an object such as a human being exists in an image. The restoring unit 106 restores an image of the inpainting region 400 using its surrounding information to be consistent with its surrounding environment. The surrounding information may include an image of, e.g., a street and a tree around a place where the human being is located as illustrated in FIG. 4A.

FIG. 4B shows an example of an inpainting region 402 that is set to include a location where a box style object exists in an image. The restoring unit 106 restores an image of the inpainting region 402 using its surrounding information to be consistent with its surrounding environment. The surrounding information may include an image of, e.g., a tree around a place where the box style object is located as illustrated in FIG. 4B.

FIG. 4C shows an example of an inpainting region 404 that is set to include a location where a vehicle exists in an image. The restoring unit 106 restores an image of the inpainting region 404 using its surrounding information to be consistent with its surrounding environment. The surrounding information may include an image of, e.g., a street and a tree around a place where the vehicle is located as illustrated in FIG. 4C.

The similarity comparing unit 108 calculates a similarity value by measuring the similarity between the image restored by the restoring unit 106 and the original image, determines whether the similarity value is greater than or smaller than a reference value that is predetermined to decide whether an object is present or not, and checks whether the object is present or not based on the determination result.

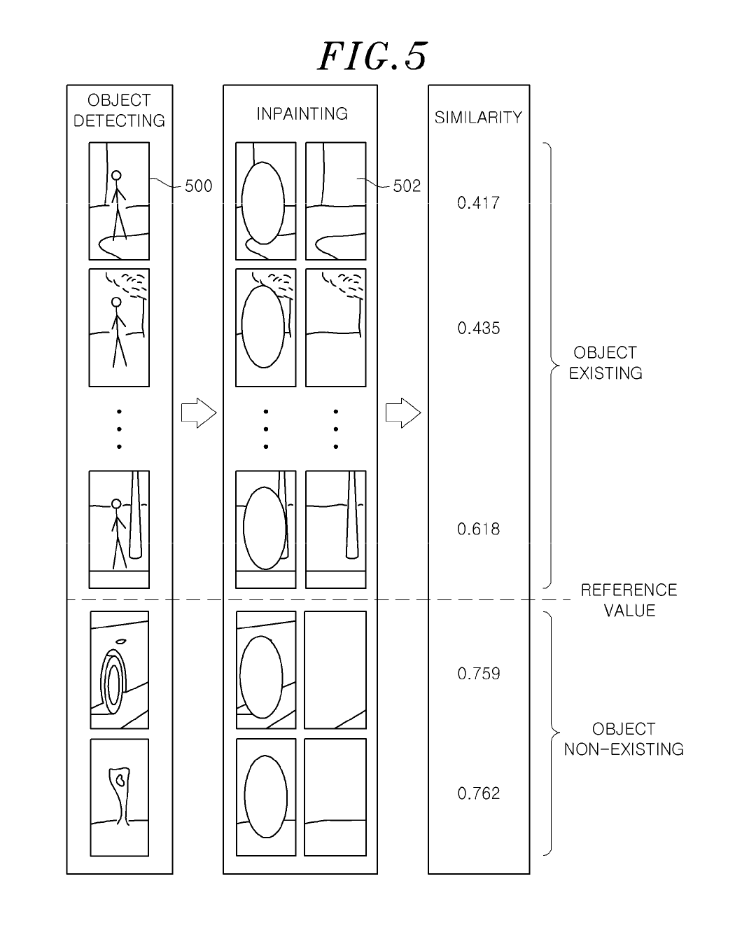

The similarity comparison between the restored image and the original image may be achieved by a variety of methods, e.g., a method of comparing the restored image with the original image using a histogram, a method using dynamic time warping, or a method of raising and adding a difference between the restored image and the original image. For instance, as shown in FIG. 5, the similarity comparing unit 108 obtains a difference between a restored image 502 and an original image 500, calculates a similarity value by counting pixels corresponding to a difference that is greater than a preset critical value, and determines that an object is present in an inpainting region if the calculated similarity value is smaller than a reference value.

If the similarity comparing unit 108 determines that the object is present in the inpainting region, the object region separating unit 110 separates an object region where the object exists in the inpainting region.

Since the restored image may be determined to include only surrounding information except the object (foreground), it is possible to extract the object region by obtaining the difference between the restored image and the original image and determining a pixel part where the restored image is definitely different from the original image as foreground information for the object.

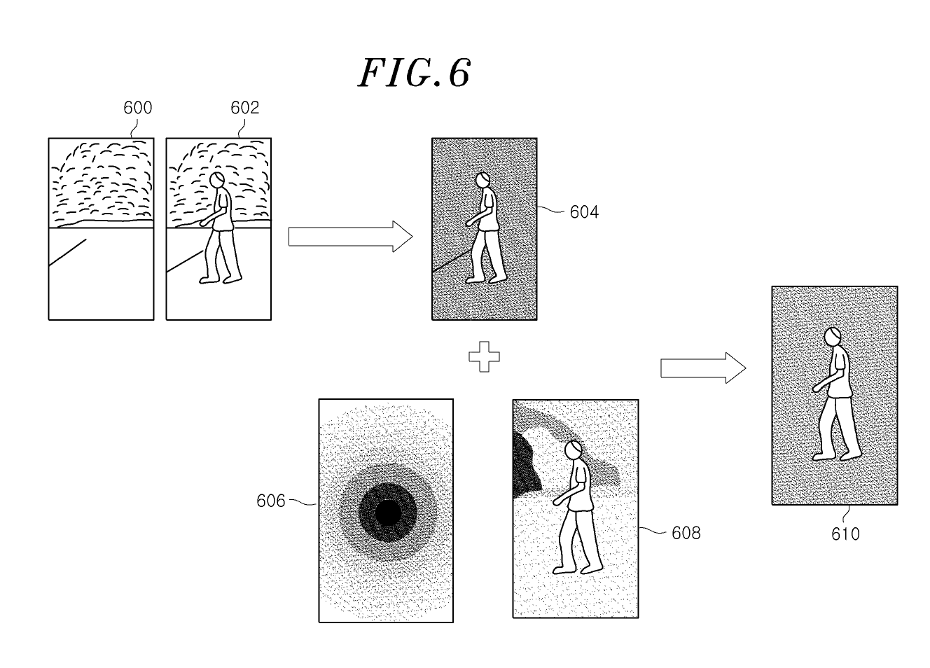

FIG. 6 illustrates a conceptual view of separating an object region existing in an original image, which is performed by the object region separating unit 110.

Referring to FIG. 6, the object region separating unit 110 extracts an object (foreground), which is present in an original image 602, by comparing a restored image 600 and the original image 602, and extracts an object region from the original image by calculating a separated object region 610 on which a separated image 608 and a prior probability 606 of an object location are reflected for an object image 604 of the extracted object (foreground).

As described above, in accordance with embodiments of the present invention, when detecting an object in an original image captured by an image capturing device, it is possible to more accurately detect the object by detecting a location of the object using a thermal image for the captured image, designating a region of the detected object as an image inpainting region, restoring a region corresponding to the region of the detected object using its surrounding information, examining a difference between the restored image and the original image, and separating an object region from the original image.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. An apparatus for detecting an object in an input image, the apparatus comprising:
an object detecting unit configured to detect the object from the input image using a thermal image;
an inpainting region setting unit configured to set up an inpainting region based on the detected object of the object detecting unit;
a restoring unit configured to restore the inpainting region using its surrounding information in the input image;
a similarity comparing unit configured to determine whether or not the object is present in the input image by comparing the input image with a restored image where the inpainting region is restored; and
an object region separating unit configured to extract an object region based on a difference between the restored image and the input image if it is determined that the object is present in the input image.

2. The apparatus of claim 1, wherein the object detecting unit is configured to detect the object using the thermal image by sequentially moving a region of a fixed size within the input image according to a sliding window scheme.

3. The apparatus of claim 2, wherein the object detecting unit is configured to count the number of pixels having a temperature in an object being searched for in the fixed sized region using the thermal image, and check the presence of the object by applying an object verification algorithm to the fixed sized region if the counted pixel number is greater than or equal to a reference value.

4. The apparatus of claim 3, wherein the object detecting unit is configured not to apply the object verification algorithm to the fixed sized region if the counted pixel number is smaller than the reference value.

5. The apparatus of claim 2, wherein the fixed sized region includes a rectangle or a basic diagram.

6. The apparatus of claim 1, wherein the inpainting region setting unit is configured to change a shape of the inpainting region to fit a shape of the object when setting the inpainting region.

7. The apparatus of claim 1, wherein the similarity comparing unit is configured to calculate a similarity value between the restored image and the input image and determine that the object is present in the inpainting region if the similarity value is greater than a predetermined reference value.

8. The apparatus of claim 7, wherein the similarity value is obtained by a similarity comparing method using a histogram between the restored image and the input image, a method using dynamic time warping, a method of raising and adding a difference between the restored image and the input image, or a method of obtaining a difference between the restored image and the input image and counting pixels corresponding to a difference that is greater than a preset value.

9. The apparatus of claim 1, wherein the object region separating unit is configured to extract panorama information of the object through the comparison of the restored image and the input image, reflect a prior probability of a location of the object and an image separation result for the input image onto the panorama information, and separate the object region from the input image.

10. A method of detecting an object in an input image, the method comprising:
detecting the object from the input image using a thermal image;
setting an inpainting region based on the object detection result;
restoring the inpainting region using its surrounding information in the input image;
comparing the input image with a restored image where the inpainting region is restored to determine whether or not the object is present; and
extracting an object region from the input image by obtaining a difference between the restored image and the input image if it is determined that the object is present.

11. The method of claim 10, wherein said detecting the object comprises detecting the object using the thermal image by sequentially moving a region of a fixed size within the input image according to a sliding window scheme.

12. The method of claim 11, wherein said detecting the object comprises:
counting the number of pixels having a temperature in an object being searched for in the fixed sized region using the thermal image; and
checking the presence of the object by applying an object verification algorithm to the fixed sized region if the counted pixel number is greater than or equal to a reference value.

13. The method of claim 12, wherein said detecting the object further comprises un-applying the object verification algorithm to the fixed sized region if the counted pixel number is smaller than the reference value.

14. The method of claim 11, wherein the fixed sized region includes a rectangle or a basic diagram.

15. The method of claim 10, wherein the inpainting region is set to various diagrams corresponding to a shape of the object.

16. The method of claim 10, wherein said determining whether or not the object is present comprises:
obtaining a similarity value by measuring the similarity between the restored image and the input image; and
determining that the object is present in the inpainting region if the similarity value is greater than a predetermined reference value.

17. The method of claim 16, wherein the similarity value is obtained by performing a similarity comparing method using a histogram between the restored image and the input image, a method using dynamic time warping, a method of raising and adding a difference between the restored image and the input image, or a method of obtaining a difference between the restored image and the input image and counting pixels corresponding to a difference that is greater than a preset value.

18. The method of claim 10, wherein said extracting the object region comprises:
extracting panorama information of the object through the comparison between the restored image and the input image;
reflecting a prior probability of a location of the object and an image separation result for the input image onto the panorama information; and
separating the object region from the input image.
